(19) United States
(12) Patent Application Publication
(10) Pub. No.: US 2019/0111700 A1
(43) Pub. Date: Apr. 18, 2019

(54) BUBBLE TRAP

(71) Applicant: Hewlett-Packard Development Company, L.P., Houston, TX (US)

(72) Inventors: Cherng Linn Teo, Singapore (SG); Jason M Quintana, Vancouver, WA (US); Tian Cheng Tang, Singapore (SG)

(21) Appl. No.: 16/089,516

(22) PCT Filed: Apr. 21, 2016
(86) PCT No.: PCT/US2016/028668

§ 371 Date: Sep. 28, 2018

(51) Int. Cl. B41J 2/19; B41J 2/175

(52) U.S. Cl. CPC B41J 2/19; B41J 2/17513

(57) ABSTRACT

A component: a chamber with an inlet; a passage connecting a lower portion of the chamber with an outlet; a vent connecting an upper portion of the chamber with the passage; and a barrier to block the vent forming a bubble trap, such that air bubbles from the chamber do not pass though the vent into the passage.

### BACKGROUND

In some examples, printheads and other liquid delivery systems may be vulnerable to particles and bubbles in their feed stream. Particles and bubbles may block delivery of a liquid. Filters may be used to remove particles, but may prevent the passage of bubbles. In some cases, bubbles can accumulate on the filter, limiting the ability of the system to provide printing fluid, for example, to a printhead

### BRIEF DESCRIPTION OF THE DRAWINGS

The accompanying drawings illustrate various examples of the principles described herein and are a part of the specification. The illustrated examples do not limit the scope of the claims. Throughout the drawings, identical reference numbers designate similar, but not necessarily identical, elements.

FIG. 1 shows a component capable of forming a bubble trap according to one example consistent with the present disclosure.

FIG. 2 shows a component with a bubble trap accordingly to one example consistent with the present disclosure.

FIG. 3 outlines a method of modifying a component according to one example consistent with the present disclosure.

FIG. 4 shows a component capable of forming a bubble trap according to one example consistent with the present disclosure.

FIG. 5 shows a component capable of forming a bubble trap according to one example consistent with the present disclosure.

FIG. 6 shows a component capable of forming a bubble trap according to one example consistent with the present disclosure.

### DETAILED DESCRIPTION

As noted above, air bubbles in a printing fluid, for example, can negatively impact the performance of ejector systems, such as a printhead. Such gas bubbles may prevent printing fluid from ejecting when desired. Conversely, gas bubbles may expel liquid when undesired. Gas bubble may clog lines or small spaces impeding delivery of printing fluid to the ejectors. This may occur in any number of liquid delivery systems and not just in printing systems.

One solution to deal with bubbles is to provide a bubble trap or air warehouse between a liquid source and an ejector head. The bubble trap includes a vertical space where bubbles will rise from the liquid and be sequestered. The bubble trap has an outlet, generally near or at the bottom, that allows liquid without bubbles to proceed to the next portion of the device. Thus, the bubble trap functions as a density based separator, removing the low density bubbles from the liquid and containing them in the bubble trap.

In order for the bubble trap to be effective, the area where the bubbles will be trapped needs to be filled with liquid. Otherwise, there will be no space to contain the bubbles and the bubbles will proceed to the ejector head.

Consequently, immediately following manufacture, the device may be shipped with the bubble trap prefilled with liquid, rather than attempting to empty the air from the bubble trap during installation of the device. However, shipping components prefilled with liquid can result in additional costs and challenges. For example, installing and attaching filled components can result in liquid leakage and mess. Additionally, installing a liquid-filled component can introduce gas into the lines behind a substantial amount of liquid. This can result in wasted liquid. This can also result in bubbles that may impact the output at an unexpected future point in time.

Additionally, any air trapped in a prefilled component may expand or contract due to temperature and pressure changes during shipping. This expansion and contraction can result in pressure changes and may stress the seals containing the printing fluid in the prefilled component. The prefilled component should not be stored in near freezing temperatures due to the risk of stress and/or failure of the seals. Shock and vibration can stress the seals due to the mass of the printing fluid. Water vapor loss, for example, by diffusion through the component walls, can cause bubbles in the prefilled component to grow in size. This may occur if the prefilled component is in inventory for a lengthy period of time. The seals containing the printing fluid in a prefilled component need to be correctly removed as part of installation. This adds additional steps and complexity to installation of the component.

To address these and other issues, this specification describes, among other examples, a component that is shipped dry (i.e. without liquid). The component is loaded in place and filled with liquid while expelling the air from the component. The component then may serve as a bubble trap for gas bubbles in liquid provided to the component, preventing the gas bubbles from exiting the component.

Accordingly, the present specification describes, among various examples, a component: a chamber with an inlet; a passage connecting a lower portion of the chamber with an outlet; a vent connecting an upper portion of the chamber with the passage; and a barrier to block the vent and form a bubble trap, such that air bubbles from the chamber do not pass though the vent into the passage.

The present specification also describes, among the examples, a component including a bubble trap, the component including: A component including: a chamber with an inlet; a passage connecting a lower portion of the chamber with an outlet; a vent connecting an upper portion of the chamber with the passage; and a moveable barrier to selectively block the vent and form a bubble trap.

The present specification also describes a method of forming a bubble trap by imposing a barrier in a vent between an upper portion of a chamber and a passage, the barrier to permit passage of air when dry and prevent passage of air bubbles when wet.

For purposes of this specification and the associated claims, the term “barrier” is used to describe any of several devices that are able to permit the passage of free air, but prevent the passage of air bubbles. In other words, the barrier will pass air when dry, but block air bubbles if wet in a liquid where air bubbles may be present. As will be explained in various examples below, a barrier may be a moveable barrier that can be open to permit the passage of free air when no liquid is present and then closed to prevent the passage of air bubbles when a liquid is present. Examples of moveable barriers including barriers that move mechanically, such as by sliding or turning, and barriers that move by swelling or changing shape.

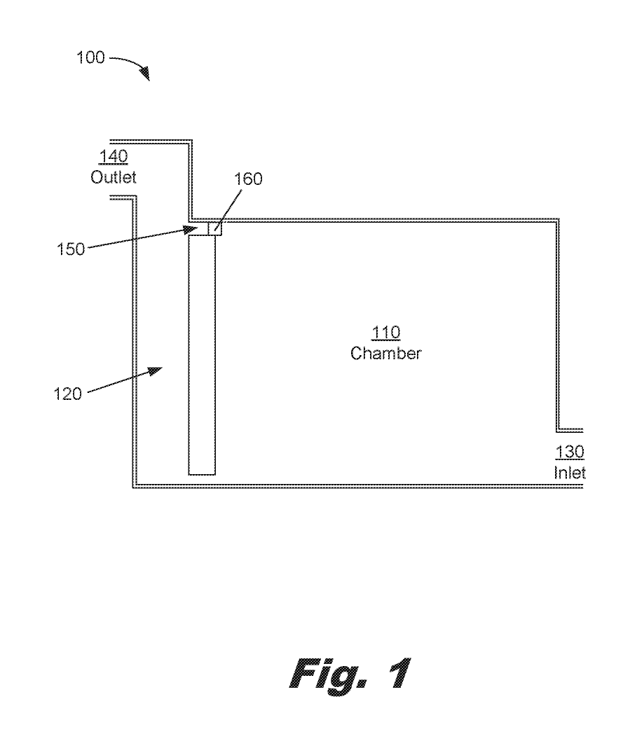

FIG. 1 shows a component (100) capable of forming a bubble trap according to one example consistent with the present disclosure. The component (100) includes a chamber (110) with an inlet (130) and an outlet (140). The chamber (110) has a passage (120) exiting from the bottom portion of the chamber (110) and leading to the outlet (140). A vent (150) also connects an upper portion of the chamber (110) to the passage (120). The outlet (140) is located higher than the vent and may also be higher than the top of the chamber (110).

A barrier (160) is used to regulate the operation of the vent. As described above, when the chamber (110) is being filled with liquid, presumably after being installed, the air in the chamber (110) needs to escape through the vent (150) to the outlet (140). However, when the chamber (110) has then been filled, any air bubbles in the liquid should be prevented from exiting the vent (150) to the outlet (140). This is accomplished by the barrier (160). As will be described below, the barrier (160) may be a moveable barrier that is put into place to completely block the vent (150) after the chamber (110) has been filed and the air originally there expelled. In another example, the barrier (160) may be a screen or mesh that permits free air to pass, but then prevents air bubbles in a liquid from passing.

In the example of a printer or printing device, the outlet (140) is connected to a printhead or similar device where it is desirable to provide bubble-free printing fluid to the device. Printing fluid is provided through the inlet (130). The liquid fills the bottom of the chamber (110) and blocks the escape of any trapped air through the entrance to the passage (120). During installation, as the printing fluid level rises, the trapped air in the chamber (110) is expelled through the vent (150). The printing fluid level rises in both the passage (120) and the chamber (110), wetting out both of them and flushing the trapped air out through the outlet (140). Once wetting has occurred, the barrier (160) prevents the passage of air bubbles, converting the chamber (110) into a bubble trap.

In use, the chamber (110) then contains printing fluid and trapped bubbles. As printing fluid arrives through the inlet (130), any bubbles in the printing fluid float up in the chamber and are trapped. The accumulated bubbles displace some of the liquid stored in the chamber (110). The opening to the passage (120) draws liquid without bubbles from the lower portion of the chamber (110). The opening to the passageway (120) may be in the wall of the chamber (110). The opening to the passageway (120) may be in the bottom of the chamber (110). Thus, the chamber acts as a density separator. Low density phases, such as bubbles are captured and retained while higher density phases, such as printing fluid are provided without bubbles.

The passage (120) is preferable not so small as to add significant flow resistance to the liquid passing through the passage (120). The liquid, having been separated from bubbles in the chamber (110) is now substantially bubble-free. The passage may include a filter to trap particles.

The inlet (130) may be in the top, bottom, and/or side wall of the chamber (110). In some examples, there are multiple inlets (130) into the chamber (110). The inlet (130) may be remote from the entrance to the passage (120). If the inlet (130) and entrance to the passage (120) are close, then small bubbles in the printing fluid may not separate from the printing fluid while in the chamber and may bypass the bubble trap.

The inlet (130) may include an adaptor or connector. The inlet (130) may be attached to a printing fluid supply. Any air accidentally introduced during attachment may be pushed out of the component (100) as part of filling of the bubble trap with printing fluid.

Similarly, the outlet (120) may contain an adaptor or connector. The outlet (140) provides the de-bubbled printing fluid for use. For example, the outlet (140) may connect to a printhead. During the initial filling of the component (100), the outlet (140) expels the gas in the chamber (110) and passage (120).

As described above, the vent (150) provides an escape route for air in the chamber (110) during filling. Without the vent (150), the liquid level in the chamber (110) would rise to the top of the entrance to the passage (120). The remaining air would then be trapped in the top of the chamber (110). This would render that part of the chamber (110) unusable as a bubble trap because that part of the chamber (110) would already be filled with air. In some examples, the vent (150) exits from the top of the chamber (110). If the vent (150) is lower than the top of the chamber (100) then a portion of the air in the chamber may not be flushed out during filling. This may result in a portion of the chamber (110) being unused since air filled portions of the chamber (110) will not accommodate new bubbles.

The vent (150) may be positioned below the outlet (140). This facilitates expelling all the air from the chamber (110) out the vent (150) and through the outlet (140) during filling of the chamber (110) with liquid. In some examples, the passage (120) may be desirable to have a slope between the vent (150) and the outlet (140) to guide the expelled air toward the outlet (140). In some examples, the passage (120) runs vertically from the lower portion of the chamber (110) to the outlet (140). This means that the passage (120) does not have a local maximum between the vent (150) and the outlet (140). A local maximum between the vent (150) and the outlet (140) may function as a dead space and trap air. The use of a continuous, non-zero slope between the vent (150) and the outlet (140) may help to avoid incomplete flushing out of the air while filling the component (100) with printing fluid.

The opening from the chamber (110) to the passage (120) may be larger than the size of the vent (150). The opening from the chamber (110) to the passage (120) may have a larger cross sectional area than the cross sectional area of the vent (150). The opening to the passage (120) from the chamber (110) may impact the flow dynamics and resistance to moving printing fluid from the inlet (130) to the outlet (140). Accordingly, it may be advantageous to provide a tapered opening, a larger opening, and/or a larger diameter and/or principle axis and/or minor axis of the passage (120) to reduce the losses from moving the printing fluid into and/or through the passage (120).

In some examples, the top of the chamber (110) is sloped toward the vent (150). This may reduce the volume of the chamber (110) while helping to remove all the air in the chamber (110) during filling. The top of the chamber (110) may include multiple slopes to guide trapped air toward the vent (150). The top of the chamber (110) may be flat in storage or as shipped but sloped when installed because the component (100) is installed at an angle. Installing the component (100) at an angle may allow more efficient use of space in the component (100).

In some examples, the outlet (140) is located above the vent (150). This may facilitate flow of gas from the chamber (110) through the vent (150) and out through the outlet (140) when filling the component (100). It is also possible to design an outlet (140) that is at the same height as the vent (150). This may allow for a more compact component (100). It is feasible to design a component (100) with an outlet (140) below the vent (150). In such designs, the component (100) may rely on liquid flow and/or entrainment to get the gas in the chamber (110) out the vent (150) while filling the component. Potential challenges include modeling the fill time for the liquid traveling through the passage (120) vs. the liquid traveling through the vent (150) to the output (140). The shape of the cross-section of the passage between the vent (150) and the output (140) can help reduce the likelihood of gas being trapped in the passage (120) and/or chamber (110) rather than being expelled through the output (140). However, in many cases, the design simplicity of placing the vent (150) below the output (140) increases robustness of the component (100) to variation in liquid properties.

The upper portion of the passage (120) between the vent (150) and the outlet (140) may be sloped. The slope may be a constant gradient. The upper portion of the passage (120) between the vent (150) and the outlet (140) may be a curve. The diameter of the portion of the passage between the vent (150) and the outlet (140) may be smaller than the diameter of the passage (120) between the opening to the chamber (110) and the vent (150). This may allow efficient gas removal while maintaining lower pressure losses through the passage (120). A smaller vent (150) diameter may be more effective for preventing bubbles from being trapped.

As indicated above, the barrier (160) may be one of a number of different devices. For example, blocking the vent (150) may be accomplished by a movable barrier that slides into place to close the vent (150). Such a moveable barrier moves between a first position and a second position. In the first position, the movable barrier does not block the vent. In the second position, the movable barrier blocks the vent. Fully blocking the vent after the chamber is filled allows the chamber to function as a bubble trap by keeping the gas bubbles away from the outlet (140). In another example, the movable barrier may be a screw that can be adjusted to seal or open the vent (150).

In still other examples, the movable barrier (160) may be a portion of a wall of the vent (150). For example, a portion of the vent (150) may be a flexible tube. The flexible tube may be pinched and/or pressed closed to block the vent (150). This may be performed by a spring loaded pressing surface that is activated by a user. in other examples, the pressing surface may be activated by the printing system or automatically as part of filling the component (100) with liquid.

Thus, in examples where the barrier is moved mechanically, the barrier may include an actuator that can be activated or released. The actuator may be a spring, piston or an electronic actuator, such as a piezoelectric element or motor. Consequently, the blocking of the vent (150) may be accomplished by providing a signal to an actuator of the component to move the barrier to block the vent. For example, an electrical signal could be provided from the printhead via wiring or possibly via conductive printing fluid to actuate or release a movable barrier (160).

The movable barrier (160) may move in a single direction. For example, the movable barrier (160) may have catches, latches, and/or similar mechanical features that facilitate its movement in a first direction while impeding or preventing motion in the opposite direction. The movable barrier (160) may comprise material that swells in response to exposure to printing fluid. This swelling may be irreversible.

In still another example, the barrier may be an element that swells in contact with the liquid. For example, the movable barrier could include a hydrophilic polymer or a hydrophilic, crosslinked polymer. This avoids the need for mechanical adjustment to close the vent (150) by the user after filling the chamber (110). This swelling may be irreversible.

In still other examples, the movable barrier (160) is held in place with a water soluble restraint. Once the restraint weakens and/or dissolves due to contact with the printing fluid, the movable barrier (160) is released and blocks the vent (150). The vent (150) may be blocked by a mesh, screen, or fibers. When dry, the mesh/screen/fibers allow the air in the chamber to pass through. However, once wetted, the mesh/screen/fibers prevent the passage of bubbles.

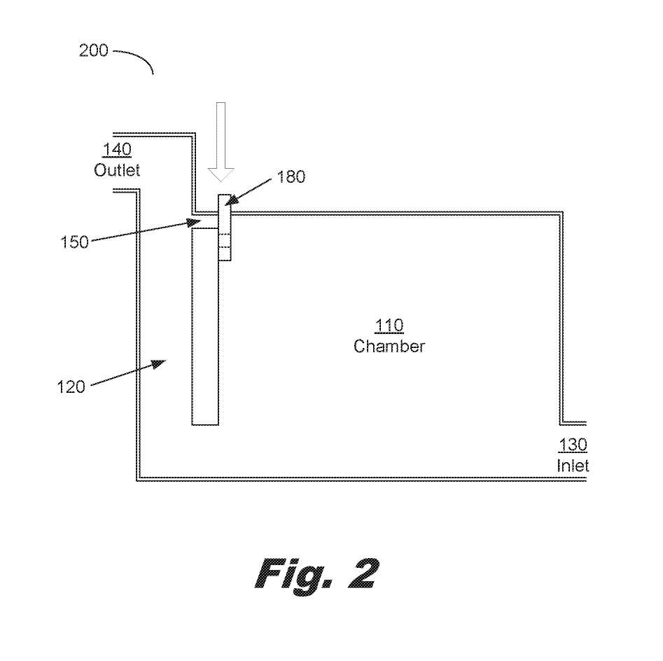

FIG. 2 shows a component (200) with a bubble trap accordingly to one example consistent with the present disclosure where a slidable barrier (180) is used. As with the example of FIG. 1, the component (200) includes a chamber (110) with an inlet (130). The chamber (110) has a passage (120) exiting the bottom of the chamber (110) and leading to an outlet (140). The outlet (140) is located higher than the top of the chamber (110). The chamber (110) is also connected to the passage (120) by a vent (150) located at the top of the chamber (110). The chamber (110) and passageway (120) are filled with printing fluid. The vent (150) is blocked by the movable barrier (180). This allows the chamber (110) to act as a bubble trap. Any bubbles in the chamber (110) are trapped. The bubbles cannot pass through the blocked vent (150). The bubbles cannot escape out the passageway (120) because the liquid is provided from the bottom of the chamber (110), away from the trapped bubbles.

The moveable barrier (180) moves between a first position and a second position. In the first position, the movable barrier (180) does not block the vent (150). In the second position, the movable barrier (180) blocks the vent. Blocking the vent (150) allows the chamber (110) to function as a bubble trap, by keeping the gas bubbles away from the outlet (140).

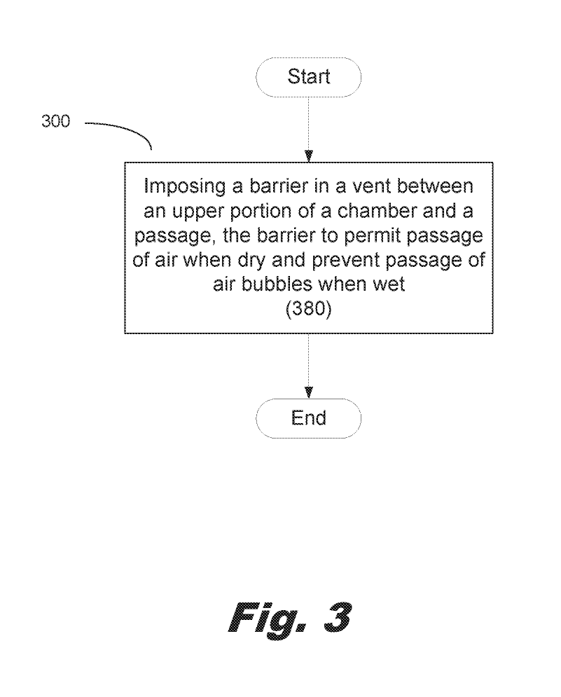

FIG. 3 is a flow chart illustrating a method of forming a bubble trap according to one example consistent with the present disclosure. The illustrated method (300) of forming a bubble trap includes imposing (380) a barrier in a vent between an upper portion of a chamber and a passage, the barrier to permit passage of air when dry and prevent passage of air bubbles when wet

As described above, imposing the barrier to control the vent can be accomplished with a variety of techniques. However, in these examples, the methods of using the barrier include allowing free air to escape as the vented chamber is filled with liquid and then, subsequently, when the chamber is filled, preventing the passage of air bubbles out of the chamber.

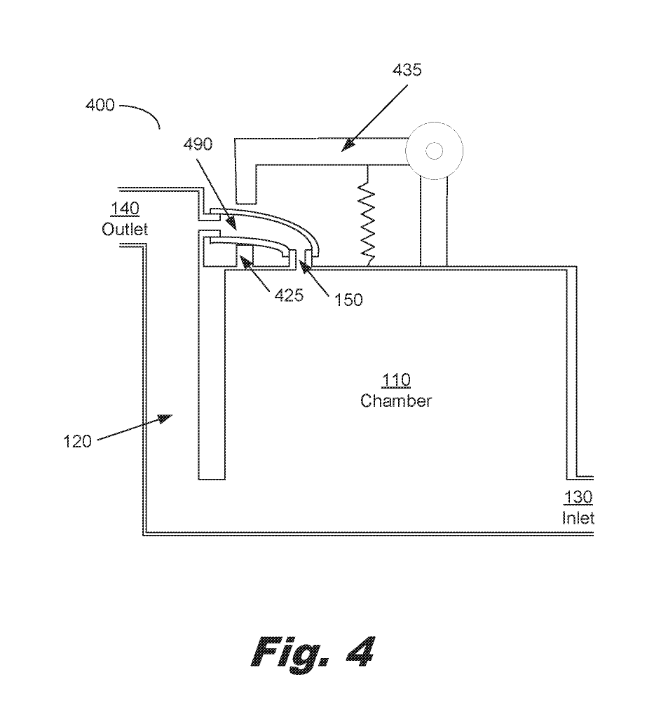

FIG. 4 shows a component (400) capable of forming a bubble trap according to one example consistent with the present disclosure. The component (400) includes a chamber (110), a passage (120), an inlet (130), and an outlet (140). The vent (150) connecting the top of the chamber (110) and the passage (120) includes a flexible section (490). The vent (150) can be blocked by pinching and/or pressing the sides of the flexible section (490) together. A surface (425) provides reaction force for a pressor (435) to apply pressure on the flexible section (490) of the vent (150).

In one example, the flexible section (490) is tubing. The flexible section (490) may be, for example, EPDM rubber (ethylene propylene diene monomer (M-class) rubber) tubing material. Flexible tubing with suitable, low water vapor transmission rates and oxygen transmission rates is preferable. The use of a flexible section (490) made of flexible tubing can enable simple actuation mechanisms. Tubing can provide an effective and robust seal compared to mechanical parts. Tubing can be obstructed with little mechanical force. Because the obstruction acts from the backside of the tubing wall, blocking the tubing doesn't provide a potential leakage path for the printing fluid. In contrast, mechanical sliders often have a seam or gap between the slider and the part that connects the actuator with the blocking portion. Tubing may have fewer specifications compared with mechanical parts, making it cheaper and easier to source and produce. The removable nature of the tubing fluidic connections may allow a technician to disconnect an end of the tubing and empty air from the chamber (110) after installation. The technician can then reconnect the tubing once the air is purged. Fingers can be used to pinch the tubing and regulate the flow of air and printing fluid out of the chamber (110). Transparent tubing may make this easier.

In one example, the flexible section (490) is compression fit onto the other portions of the vent (150). In another example, the flexible section (490) is attached with connectors, clamps, ties, and/or similar mechanical methods.

The component (400) may also have a surface (425) that rests next to the flexible section (490) and facilitates closure of the vent (150). The surface (425) provides a reaction force to allow the pressor (435) or other mechanical component to close the flexible section (490) by applying pressure to the flexible section (490)

The pressor (435) may be a spring actuated pressor. The pressor (435) may include an actuator. The pressor (435) may be moved manually. The pressor (435) provides pressure against the flexible section (490) so as to block the vent (150).

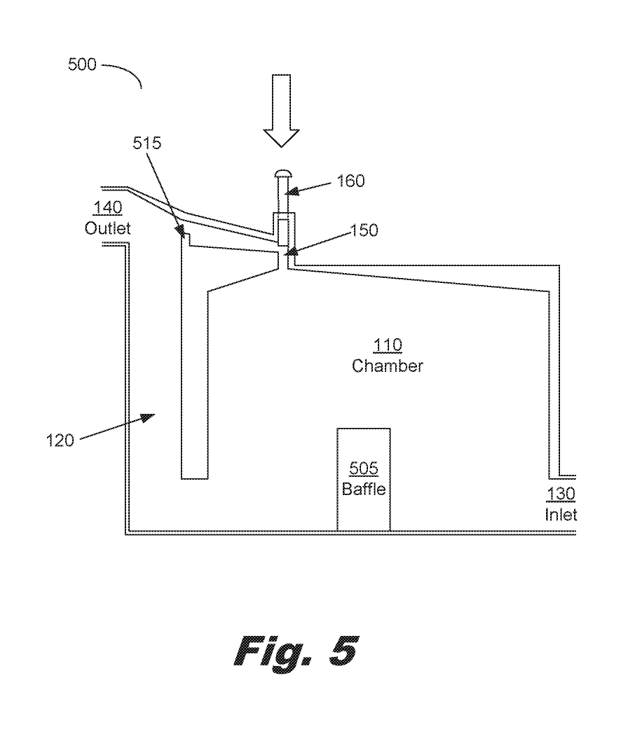

FIG. 5 shows a component (500) capable of forming a bubble trap according to one example consistent with the present disclosure. The component (500) includes a chamber (110), a passage (120), an inlet (130), and an outlet (140). The vent (150) connecting the top of the chamber (110) and the passage (120) and can be blocked using the movable barrier (160). The chamber (110) also contains a baffle (505) that lengthens the length of the flow path between the inlet (130) and an opening to the passage (120). The vent (150) includes a nub (515) at the base of the connection between the vent (150) and the passage (120).

FIG. 5 shows an example of the sloped top of the chamber (110) and sloped passage (120) between the vent (150) and the outlet (140). In one example, the movable barrier (160) is a one-way pressable button. In a second example, the movable barrier (160) is a screw that can be moved in and/or out. The movable barrier (160) may have a wider back portion, texturing, and/or similar elements to avoid leaks and enhance contact between the movable barrier (160) and the vent (150). In one example, the movable barrier (160) is molded as part of the component (400). The movable barrier (160) may be detached prior to use or may be coupled to the component (400) by a tether.

The chamber (110) may include a baffle (505). The baffle (505) may increase the length of the flow path between the inlet (130) and the opening to the passage (120). In some examples, the chamber includes multiple baffles (505). The baffle (505) may increase the transit time in the chamber (110) to help smaller bubbles escape the printing fluid. The baffle (505) may extend partially from the bottom of the chamber (110) to use the vertical dimension to increase the length of the flow path and thus the transit time in the chamber (110). The baffle (505) may extend from a side of the chamber (110). The baffle (505) may include a plurality of small holes to allow the passage of liquid while retaining and redirecting bubbles towards the bubble trap. Flow modeling of the liquid path through the chamber (110) and passage (120) with different liquid heights (i.e. different amounts of captured gas) may be helpful for optimization of a specific component (500) footprint and liquid viscosity.

In some examples, the nub (515) located at the bottom of the vent 150) increases the time before printing fluid from the passage (120) blocks the vent (150). The addition of a nub (515) can provide additional time to fully expel the gas from the chamber (110) and avoid trapping bubbles. The nub (515) reduces the cross sectional area of the vent (150) compared with the cross sectional area of another portion of the vent (150). The use of a nub (515) may provide an effective method to fine tune the expulsion of air during filling of the component (500) with printing fluid.

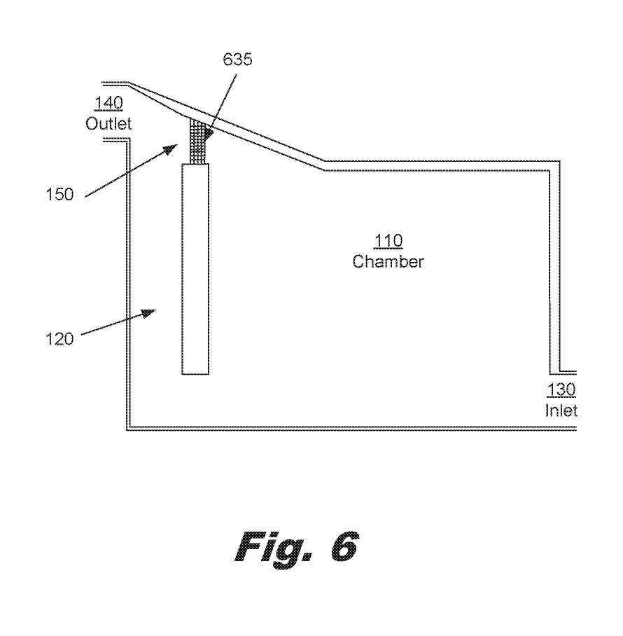

FIG. 6 shows a component capable of forming a bubble trap according to one example consistent with the present disclosure. The component includes a chamber (110), a passage (120), an inlet (130), and an outlet (140). The vent (150) connects the top of the chamber (110) and the passage (120). The vent contains a screen (635) that blocks the vent (150) once the screen (635) is wetted by the printing fluid.

The screen (635) does not prevent the flow of gas when filling the chamber (110) and passage (120) with printing fluid. However, once the chamber (110), passage (120), and screen (635) are filled with printing fluid, the screen blocks bubbles from passing through the screen (635). This is because the bubbles would need to form more surface area to divide and pass through the screen (635). In one example, absent a significant pressure gradient, vibration, or other sort of energy, the bubbles may remain blocked by the wetted screen (635), unable to pass through. The use of a screen (635) avoids a mechanical part passing from the outside of the component to the chamber (110) with a potential leak path. The automatic behavior of the screen (635) also avoids the need for a user or system based activation, as the screen (635) functions automatically once the component is filled with liquid. The screen (635) can be a mesh or a collection of fibers and/or filaments and does not need to be composed with a regular pattern, such as uniform squares.

Within the principles described by this specification, a vast number of variations exist. The examples described are examples, and are not intended to limit the scope, applicability, or construction of the claims.

What is claimed is:

1. A component comprising:
a chamber with an inlet;
a passage connecting a lower portion of the chamber with an outlet;
a vent connecting an upper portion of the chamber with the passage; and
a barrier to block the vent and form a bubble trap, such that air bubbles from the chamber do not pass though the vent into the passage.

2. The component of claim 1, wherein the barrier is a movable barrier.

3. The component of claim 2, wherein the movable barrier is to slide between a first position blocking the vent and a second position that opens the vent.

4. The component of claim 2, wherein the movable barrier comprises a screw.

5. The component of claim 2, wherein the movable barrier comprises a wall of the vent.

6. The component of claim 1, wherein an opening from the chamber to the passage is larger than the vent.

7. The component of claim 1, wherein a top of the chamber is sloped toward the vent.

8. The component of claim 1, wherein the outlet is located above the vent.

9. The component of claim 1, wherein the barrier is a screen.

10. The component of claim 9, wherein the screen permits air to pass when dry, but prevents air bubbles from passing when the screen is in a liquid.

11. A component comprising:
a chamber with an inlet;
a passage connecting a lower portion of the chamber with an outlet;
a vent connecting an upper portion of the chamber with the passage; and
a moveable barrier to selectively block the vent and form a bubble trap.

12. The component of claim 11, wherein the passage runs vertically from the lower portion of the chamber to the outlet.

13. A method of forming a bubble trap, the method comprising:
imposing a barrier in a vent between an upper portion of a chamber and a passage, the barrier to permit passage of air when dry and prevent passage of air bubbles when wet.

14. The method of claim 13, wherein imposing the barrier comprises sliding a moveable barrier to close the vent.

15. The method of claim 13, wherein imposing the barrier comprises providing a mesh over the vent, the mesh to permit passage of air when dry and prevent passage of air bubbles when wet.
